(19) United States
(12) Patent Application Publication
(10) Pub. No.: US 2011/0059365 A1
(43) Pub. Date: Mar. 10, 2011

(54) PROCESS FOR MANUFACTURE AND ASSEMBLY OF BATTERY MODULES AND SECTIONS

(75) Inventors: Patrick J. Meehan, Ann Arbor, MI (US); Robert J. Scheuerman, Washington, MI (US); Rick F. Rourke, Metamora, MI (US)

(73) Assignee: GM GLOBAL TECHNOLOGY OPERATIONS, INC., DETROIT, MI (US)

(21) Appl. No.: 12/556,030

(22) Filed: Sep. 9, 2009

(51) Int. Cl. H01M 4/58; H01M 10/04

(52) U.S. Cl. 429/231.95; 29/623.5

(57) ABSTRACT

The present invention provides an improved rechargeable battery and method of assembling the same, including the steps of providing at least one pair of electrically biased sheets to form a plurality of positive and negative electrodes; forming a cell element from three positive electrodes spaced from three negative electrodes in an overlying orientation with a positive and negative lead terminal extending respectively therefrom; separating each of the positive and negative electrodes with a polymer layer; electrically aligning said positive lead terminals and negative lead terminals; applying a heat protectant to the positive and negative lead terminals; shaping the positive and negative lead terminals for connecting to a pair of electrode current collectors, wherein one of the collectors is associated with the positive lead terminal and the other with the negative lead terminal; and providing a frame for receiving cell elements, such that the rechargeable battery provides the desired electrical characteristics.

### FIELD OF THE INVENTION

The present invention is directed to an advanced method of manufacturing and assembling battery modules and sections, namely batteries based on Lithium-Ion electrochemical cells and related chemical analogues. In particular, the present invention is directed to a method of assembling components of lithium-ion polymer battery modules and sections.

### BACKGROUND OF THE INVENTION

Lithium ion batteries represent the state-of-the-art in rechargeable battery technology. A rechargeable lithium ion battery contains an electrolyte through which lithium atoms from a source electrode move between electrodes during charge/discharge cycles. Each individual lithium-ion cell is comprised of a conductive polymer membrane in a lithium salt matrix sandwiched between an anode and a cathode. Lithium-ion batteries are often packaged such that multiple cells are connected either in series or parallel depending on the application, which are further arranged into modules.

A battery module is comprised of stacking multiple lithium-ion polymer cells together. Each cell is encompassed by a frame. Cooling fins generally made of aluminum or other efficient heat dissipating materials are sandwiched between the stacked cells. Foam spacers are generally used to fill additional spacing to support a uniform module structure. Several assembled modules comprise what is known as a section. Several sections are electrically connected to form a rechargeable energy storage system, such as used by the automotive industry in hybrid vehicles.

Despite advances in the field of electrochemical storage, the conventional process for manufacturing such batteries remains complex and expensive, comprising a multiplicity of independently executed steps. In general, an electrochemical cell is constructed by individually cutting a plurality of anodes, cathodes and separators to the required shape and size. Individual anodes are then sandwiched between two separators. The anode-separator assembly is subsequently sandwiched between a pair of cathodes. Finally, a number of cells are stacked upon one another to make a complete battery. In batteries of the type that have a thin film polymer electrolyte and sheet-like anode and cathode layers, it is common that a relatively large number of individual cells form a battery.

Each cell is generally sandwiched between separators. The separator is necessarily comprised of a non-conductive polymer, such as polyvinyl chloride or polyvinyl fluoride. The separator provides structural rigidity while also preventing cell contact. Some thin film lithium ion polymeric cells encase the anode and cathode in a polymer providing a homogenous structure. Once the anode, cathode, and separator are combined into a unit, the current collectors are affixed.

In fabricating batteries, it is generally necessary to connect an anode to an anode current collector and a cathode to a cathode current collector so that electric energy can be drawn from the battery by an external load. In multi-cell batteries, current collectors are generally connected to each anode and each cathode, and the current connectors connected to each anode are electrically connected together and the current collectors connected to each cathode are electrically connected together.

Once the current collectors are in place, the cells are assembled into a frame or casing. The frame or casing is generally comprised of a non-conductive plastic. The frame or casing provides protection for the cells and encases the cells into a cohesive package that can be organized efficiently in larger groups of batteries which are further assembled into modules.

As it is evident from the above steps, lithium ion battery manufacturing involves many labor intensive handling operations, each of which incurs substantial investments of time and capital. The conventional manufacturing process described above represents a labor-intensive “pick and place” operation that retards the manufacturing process and thereby accelerates the costs associated therewith. Individual handling of cells is not only tedious; it also fosters improper alignment of the components of the cell assembly, leading to improper cell performance and limited yield of the number of batteries produced per production run.

It is therefore desirable to provide an improved method of assembling lithium ion batteries which not only amplifies the number of units produced but also optimizes the arrangement of components in each unit while maintaining unit integrity.

### SUMMARY OF THE INVENTION

The present invention reduces the difficulties and disadvantages of the prior art by providing an improved rechargeable battery and assembly thereof the method including the steps of providing at least one pair of electrically biased sheets to form a plurality of positive and negative electrodes; forming a cell element from three positive electrodes spaced from three negative electrodes in an overlying orientation with a positive and negative lead terminal extending respectively therefrom; separating each of said positive and negative electrodes with a polymer layer; electrically aligning said positive lead terminals and negative lead terminals; applying a heat protectant to the positive lead terminals and the negative lead terminals; shaping said positive and negative lead terminals for connecting to a pair of electrode current collectors, one of said current collectors being associated with said positive lead terminal and the other being associated with said negative lead terminal; and providing a frame for sequentially receiving plural cell elements, whereby said rechargeable battery provides the desired electrical characteristics. The present invention also includes a rechargeable battery addressing the difficulties and disadvantages of the prior art including plural pairs of positive and negative electrodes arranged in an overlying orientation presenting a positive and negative lead terminal, a polymer layer associated with an active biasing material associated with each of said positive and negative electrodes, a heat protectant associated with said positive electrodes and said negative electrodes, a pair of electrode current collectors connected to said lead terminals forming a cell assembly, and a frame having an outer frame member adapted for receiving plural said cell assemblies.

### BRIEF DESCRIPTION OF THE DRAWINGS

FIG. 1 is an environmental view illustrating a process of assembly of lithium ion batteries.

FIG. 2 is a perspective view of a cell according to FIG. 1.

FIG. 3 is a perspective view of a cell assembly according to FIG. 1.

FIG. 4 is a sectional view of stacked cell assemblies according to FIG. 1.

FIG. 5 is a top plan view of the battery module according to FIG. 1.

### DETAILED DESCRIPTION OF THE INVENTION

The present invention is directed to a lithium-ion cell assembly and method of manufacture thereof. Generally, the present invention relates to a battery pack, a lithium ion battery, for example, and a method of manufacturing such battery pack.

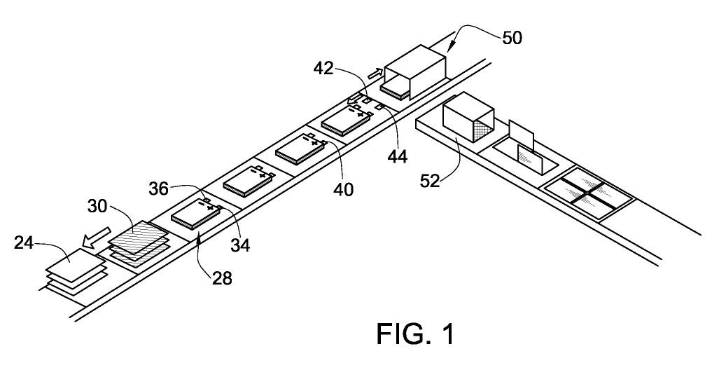

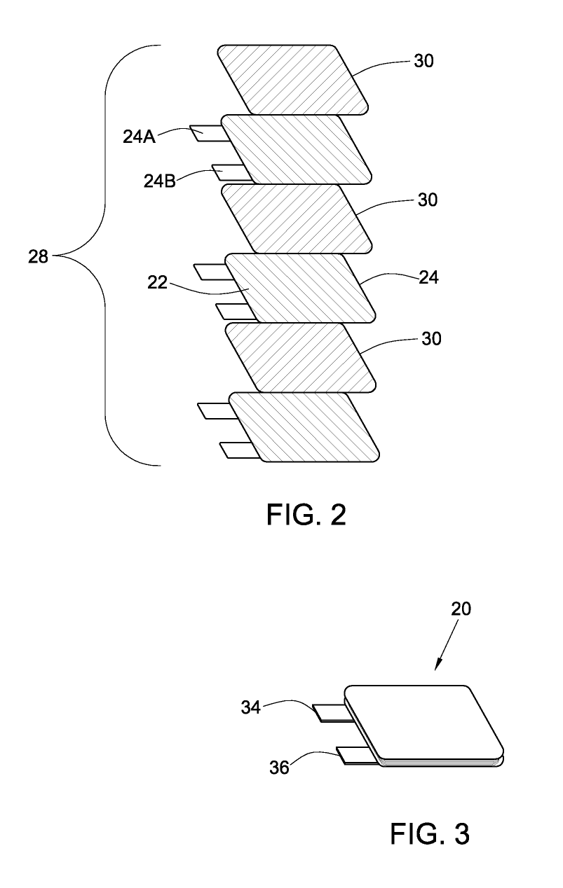

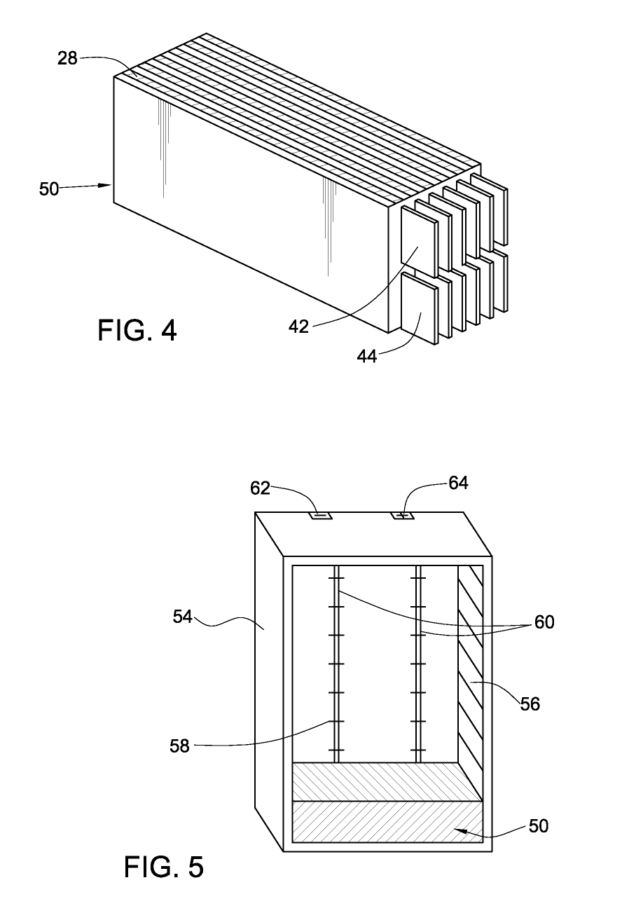

Hereinbelow, a preferred embodiment of the present invention will be described with reference to the drawings according to the assembling order. In FIGS. 1-5, reference numeral 20 generally references to a cell for a battery made of lithium ion, for example. The cell 20 includes a cell element 24 and is generally covered with a hard laminate material 22 designed to protect the cell 20.

The cell element 24 includes a positive electrode 24a, a negative electrode 24b, and is adapted for receiving a polymer and/or a separator 30 disposed between the positive and negative electrodes 24a,24b. The electrodes 24a,24b are generally positioned in an overlying orientation in relation to each other, wherein the positive electrode 24a and the negative electrode 24a are electrically connected to lead terminals 34 and 36, respectively.

The positive and negative electrodes 24a,24b are generally sheets of material with one side having a chemically active material. In the case of the negative electrode 24b, the active material is negatively biased. In the case of the positive electrode 24a, the active material is positively biased.

The polymer layer 30 is adapted for positioning between the active material on the positive electrode 24a sheet and the active material on the negative-electrode 24b sheet. The positive electrode and the negative electrode are provided with a positive-electrode terminal 34 and a negative-electrode terminal 36, respectively, from which a current generated by a potential between the negative 24b and positive electrode 24a is extracted.

The polymer 30 may be used to insulate the overlying positive and negative electrodes 24a,24b from each other preventing any undesired current leakage. The polymer 30 is generally flexible and suitable for use in the described lithium ion batteries. Alternatively, the polymer 30 may include electrolytes dissolved throughout the polymer for placement between the positive and negative electrodes 24a,24b.

The lead terminals 34,36 are electrically aligned and prepared for receiving a heat protecting element 40 such as a negative temperature coefficient (NTC) thermistor or metal insulator transition (MIT) thermistor between the lead terminals 34,36. Generally the heat protecting element 40 has high stability, productivity, resistivity, and temperature coefficient which allow it to be used as a temperature sensor. In operation, the heat protecting element 40 decreases resistance as the internal temperature increases, which is dependant, in part, upon the resistance coefficient of the heat protecting element 40. As the lithium-ion battery generates heat or is exposed to a high-temperature environment due to a change in the external environment, an internal short, other external impacts, the resistance associated with the heat protecting element 40 is lowered. As a result, the lead terminals 34,36 are shorted, forcibly discharged the lithium ion battery, and avoiding adverse effects.

In a typical configuration, the cell elements 24 may be assembled as a plurality of bi-cells which are produced from a number of sandwiched polymer layers 30 positioned between the positive 24a and negative electrodes 24b. In accordance with one aspect of the present invention, an improved process includes forming three of these bi-cells by selecting three positive electrodes 24a and three negative electrodes 24b, overlying each positive electrode 24a with the corresponding negative electrode 24b and separating them with the polymer 30, forming three bi-cells which are referred to collectively as a cell assembly 28. In this way, an improved method of manufacture is provided by the present invention.

The resulting battery may include any number of these cell assemblies 20 to create the desired electrical characteristics based upon the characteristics and dimensions of the utilized electrical material which may depend in-part on the desired use. As used herein, the depicted embodiment is within the automotive industry, although other applications may be utilized as understood by others.

As further illustrated in FIG. 1, the battery is configured with a number of cell 20 elements which are electrically connected to an anode collector 42 or cathode collector 44 respectively. In addition, the assembly of the bi-cell comprises a number of independent steps including providing a cell assembly, selecting three assemblies, applying foam between the cell assemblies, turning the cell assemblies bending of tabs, turning the cell assemblies for polarizing and applying a thermistor. In addition, at the time of selecting the cell assemblies an OCV test may be used to disregard failed cells. In operation, the steps described may facilitate a high speed assembly process which allows for the assembly of various battery components such as cells, frames and foam spacers into battery modules which may then be assembled into larger sections in comparison to the Honda Fuel Cell stacker system used to created fuel cell stacks.

The positive electrode 24a includes an active material layer formed on a sheet-like material having an extension associated with lead terminals 34,36 and adapted for receipt by the anode and cathode current collector 42,44 respectively.

In the positive electrode 24a, the active material may include, a metal oxide, a metal sulfide, or a specific polymer can be used according to the type of the desired battery. The negative active material may include a lithium-containing composite oxide comprised mainly of LiₓMO₂, wherein M represents at least one transition metal, and x generally represents 0.05 to 1.10, which varies depending on the charged state or discharged state of the battery. As the transition metal M constituting the lithium-containing composite oxide, Co, Ni, or Mn is preferred.

Specific examples of the lithium ion-containing composite oxides include LiCoO₂, LiNiO₂, LiNi_{y}Co_{1-y}O₂ wherein 0<y<1, and LiMn₂O₄. These lithium-containing composite oxides can exhibit high voltage and excellent energy density. Alternatively, as the cathode active material, a metal sulfide or oxide having no lithium, such as TiS₂, MoS₂, NbSe₂, or V₂O₅, may be used. In the positive electrode, a plurality of these negative active materials may be used in combination. Further, when the positive electrode is formed using the above-mentioned negative active material, an electrical conductor, a binder, or the like may be added.

Generally, the negative electrode 24b may include a material capable of being doped with lithium and dedoped. For example, a carbonaceous material, such as a non-graphitizable carbon material or a graphite material, can be used. More specifically, a carbonaceous material, such as pyrolytic carbon, coke (e.g., pitch coke, needle coke, petroleum coke), graphite, glassy carbon, a calcined product of an organic polymer compound (e.g., obtained by carbonization of a phenolic resin, a furan resin, or the like by calcining it at an appropriate temperature), carbon fiber, or activated carbon, can be used. Further, as the material capable of being doped with lithium and dedoped, a polymer, such as polyacetylene or polypyrrole, or an oxide, such as SnO₂, can be used. When the negative electrode 24b is formed from the above material, a binder (not shown) or the like may be added.

The polymer 30 material has such a property that it is compatible with the positive and negative electrode 24a,24b such as a silicone gel, an acrylic gel, an acrylonitrile gel, a polyphosphazene modified polymer, polyethylene oxide, polypropylene oxide, or a composite polymer, crosslinked polymer, or modified polymer thereof, or a fluorine polymer, a polymer material, such as poly(vinylidene fluoride), poly(vinylidene fluoride-co-tetrafluorosafluoropropylene), or poly(vinylidene fluoride-co-trifluoroethylene), or a mixture thereof.

The cell assembly 28 may include a casing 46 having an outer protective material such as a laminate to help protect the cell assembly 20. In addition, plural cell assemblies 20 may be arranged into a battery module 50 having a frame 52 with a pair of outer module members 54 for receiving cell assemblies 20 and an inner module member 56 disposed between the outer module members 54. The cell assemblies 20 are mounted between the outer 54 and inner module members 56. The inner module member 56 having a plurality of elongated slots 58 allowing for receipt of the cell assemblies 20. The inner module 56 members include an electrical network 60 having a negative element 62 and a positive element 64 in which the collectors 42,44 of the cell assembly 28 are electrically aligned. The frame 52 and the battery module 50 may provide space for cooling fins generally made of aluminum or other efficient heat dissipating materials to reduce any excess heat from the cell assemblies. In addition, the frame 52 may include a number of aluminum end caps.

A plurality of battery modules 50 may be successively joined into a battery section (not shown) while the cell assemblies 20 are mounted in each battery module 50. When successive battery modules 50 are connected, the outer casing of the neighboring modules provides inner module members 56 to the battery module 50 providing additional structural and operational support. Generally, the frame 52 therefore provides a plurality of grooves (not shown) to the outer module members 54, which are connected with outer module members 54 of the neighboring battery modules 50 in a stacked fashion (not shown). Also, a plurality of battery modules 50 may be electrically connected with each other to manufacture a high-output, large-capacity battery system (or battery pack). Preferably, the battery system (not shown) may include additional coupling members for coupling plural battery modules 50.

A method for manufacturing, according to the present invention, includes the steps of electrically biasing a sheet 110 with an active material to form plural positive 24a and negative electrodes 24b, forming a cell 20 element by positioning the positive electrode 24a and negative electrode 24b in an overlying orientation with the positive and negative lead terminals 34,36 extending respectively therefrom, providing a polymer layer 30 corresponding to said positive and negative electrodes 24a,24b. Three polarized cells are then selected 112 to form a cell assembly 28, separating the positive and negative electrodes 24a,24b being generally separated with the polymer layer 30. One side of the polymer layer 30 is generally associated with the active material on the positive electrode 24a and another side is generally associated with the negative electrode 24b. The cell assembly 28 is generally electrically aligned with the positive lead terminals 34 and negative lead terminals 36 being rotated. The positive electrode terminal 24a associated with said positive lead terminal 34 and negative terminal 24b associated with the negative lead terminal 36 are then bent and a heat protectant 40 (thermistor) is applied 116. The anode and cathode current collectors 42,44 are electrically connected to a plurality of positive and negative electrode lead terminals 34,36. The cell assembly 28 is inserted into a frame 52, forming the rechargeable battery. The frame 52 may be assembled 132 connecting 130 outer members 54 and inner members 56 in a parallel process where the formed frame 52 is configured during the development of the cell assembly 28 for receipt 134 of the cell assembly 28 upon completion of the formed frame.

The present invention has been described in an illustrative manner. It is understood that the terminology, which has been used, is intended to be in the nature of words of description rather than of limitation. While the invention has been described with respect to specific examples including presently preferred modes of carrying out the invention, those skilled in the art will appreciate that there are numerous variations and permutations of the above described methods, compositions and techniques that fall within the spirit and scope of the invention as set forth in the appended claims.

Having thus described the invention, what is claimed as new and desired to be secured by Letters Patent is as follows:

1. A lithium ion battery including:
(a.) plural pairs of positive and negative electrodes arranged in an overlying orientation presenting a positive and negative lead terminal,
(b.) a polymer layer associated with an active biasing material associated with each of said positive and negative electrodes,
(c.) a heat protectant associated with said positive electrodes and said negative electrodes,
(d.) a pair of electrode current collectors connected to said lead terminals forming a cell assembly, and
(e.) a frame having an outer frame member adapted for receiving plural said cell assemblies.

2. The lithium battery of claim 1 wherein said polymer layer further includes an electrolyte.

3. The lithium battery of claim 1 wherein said lead terminals are shaped for receipt by said current collectors.

4. The lithium battery of claim 1 wherein said frame further includes an electronic network in communication with said lead terminals at a pair of inner raceways associated with said frame.

5. A method of forming an electrochemical cell assembly, comprising the steps
(a.) Providing at least one pair of electrically biased sheets to form a plurality of positive and negative electrodes;
(b.) Forming a cell element from three positive electrodes spaced from three negative electrodes in an overlying orientation with a positive and negative lead terminal extending respectively therefrom;
(c.) Separating each of said positive and negative electrodes with a polymer layer;
(d.) Electrically aligning said positive lead terminals and negative lead terminals;
(e.) Applying a heat protectant to the positive lead terminals and the negative lead terminals;
(f.) Shaping said positive and negative lead terminals for connecting to a pair of electrode current collectors, one of said current collectors being associated with said positive lead terminal and the other being associated with said negative lead terminal; and
(g.) Providing a frame for sequentially receiving plural cell elements, whereby said rechargeable battery provides the desired electrical characteristics.

6. A method of assembling a lithium ion battery comprised of a plurality of lithium ion cells, comprising the steps:
(a.) Electrically biasing a sheet with an active material to form a plurality of positive and negative electrodes;
(b.) Forming a cell element by positioning the positive electrode and negative electrode in an overlying orientation with a positive and negative lead terminal extending respectively therefrom;
(c.) Providing a polymer layer corresponding to said positive and negative electrodes;
(d.) Separating said positive and negative electrodes with said polymer layer associated with said active material on said negative electrode and said active material on said positive electrode to form a cell assembly;
(e.) Electrically aligning said positive lead terminals and negative lead terminals and rotating the cell assembly;
(f.) Bending a positive electrode terminal associated with said positive lead terminal and bending a negative terminal associated with said negative lead terminal;
(g.) Applying a heat protectant to the positive electrode lead terminals and the negative electrode lead terminals;
(h.) Connecting a positive electrode current collector to a plurality of said positive electrode lead terminals;
(i.) Connecting a negative electrode current collector to a plurality of negative electrode lead terminals; and
(j.) Forming a rechargeable battery by inserting said cell assembly into a frame.

7. The method according to claim 6, further comprising the steps of:
(a.) Stacking a plurality of batteries;
(b.) Providing a frame consisting of four end caps separated from each other and each being associated with a cooling fin;
(c.) Forming a module from said stack received by said frame; and
(d.) Moving the module to a second position.
